(19) United States
(12) Patent Application Publication
(10) Pub. No.: US 2005/0125564 A1
(43) Pub. Date: Jun. 9, 2005

(54) Profiling service for the automatic service discovery and control middleware frameworks

(75) Inventors: Dennis Bushmitch, Somerset, NJ (US); Minobu Abe, Osaka (JP)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 11/004,647

(22) Filed: Dec. 3, 2004

Related U.S. Application Data
(60) Provisional application No. 60/526,774, filed on Dec. 4, 2003.

(51) Int. Cl. G06F 15/16

(52) U.S. Cl. 709/250

(57) ABSTRACT

The middleware discoverable service allows extensive dynamic profiling with respect to devices, control points and users. An XML-based discoverable service implements SOAP control and is capable of GENA eventing. This is made possible through a profiling service, compliant with UPnP protocols, which manages profile objects containing profile information of devices, users and/or services. Control points on the UPnP network may subscribe to the profiling service to receive up-to-date information about relevant profile information.

### BACKGROUND OF THE INVENTION

The present invention relates generally to universal plug-and-play (UPnP) technology. More particularly, the invention relates to a middleware discoverable service to extend the UPnP capabilities.

The UPnP architecture is designed to connect networked devices in a user-friendly way. The architecture defines a base set of standards for all devices to adhere to, and conventions for describing devices and the services they provide. The intent of the standard is to bring the PC peripheral plug-and-play concept to the home network with the same ease of use and automatic configuration that users have come to expect with plug-and-play devices. While the existing UPnP architecture has many advantages, there is still room for significant improvement, particularly in the UPnP service offering toward management of device and control point state changes and management of various profile-related informational aspects.

### SUMMARY OF THE INVENTION

As will be more fully described herein, the present invention provides a middleware discoverable service that allows extensive dynamic profiling with respect to devices, networks, control points and their users. In a presently preferred form, the middleware service is an XML-based discoverable service that implements SOAP action-based control and that is capable of GENA-based eventing. In a presently preferred form, a profiling service, compliant with UPnP protocols, manages profile objects containing profile information of devices, users and/or services. These profile objects are typically XML-structured profile information documents or their fragments. Control points on the UPnP network may subscribe to the profiling service to receive up-to-date information about relevant profile information.

For a more complete understanding of the invention, its objects and advantages, refer to the remaining specification and to the accompanying drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the prior art UPnP architecture with which the present invention may be utilized;

FIG. 2 illustrates the manner of providing state change notification according to the conventional UPnP architecture;

FIG. 3 is a flow diagram illustrating the UPnP phases implemented in a convention UPnP architecture;

FIG. 4 is an exemplary profile object of the type supported by the profiling service of the invention;

FIG. 5 is a sequence diagram illustrating the presently preferred profiling service architecture in conjunction with an auxiliary authentication service, and further illustrating the basic sequence of messages to provide profiling services to an exemplary control point;

FIG. 6 is a sequence diagram illustrating the return profile list method of the profiling service;

FIG. 7 is a sequence diagram illustrating the obtain profile method of the profiling service where the profile is imported from another location;

FIG. 8 is a sequence diagram illustrating the return profile attribute method of the profiling service;

FIG. 9 is a sequence diagram illustrating the update profile method of the profiling service; and

FIG. 10 is a sequence diagram illustrating the create ProfileUpdateID method of the profiling service.

### DETAILED DESCRIPTION OF THE PREFERRED EMBODIMENTS

The following description of the preferred embodiment(s) is merely exemplary in nature and is in no way intended to limit the invention, its application, or uses.

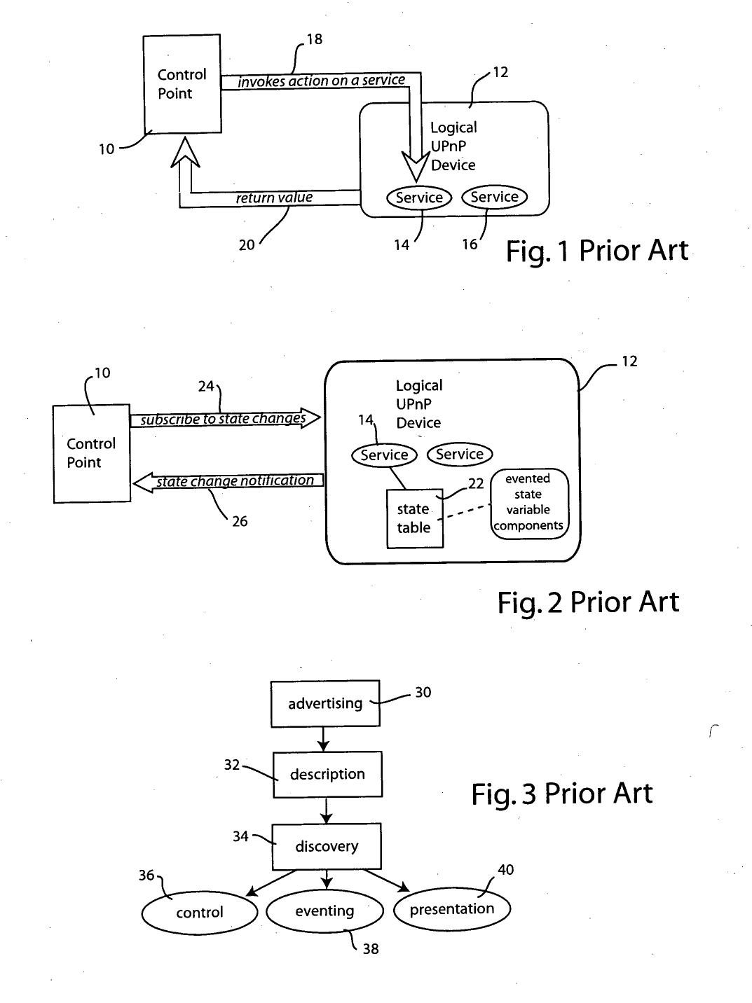

The UPnP architecture provides a framework of network layer protocols and application layer XML-based constructs. The basic components of the UPnP architecture are illustrated in FIG. 1. The control point 10 is an entity on the network that works using the functionality provided by UPnP services deployed on device such as device 12. The UPnP device can be any entity on the network that implements the protocols required by the UPnP architecture and device services complaint with UPnP architecture. Thus, device 12 can either be a dedicated physical device, such as an internet gateway, or a logical device, such as a PC or home appliance that has implemented the functionality required of an internet gateway device.

A UPnP device implements zero or more services. Device 12 in FIG. 1 illustrates two services 14 and 16, by way of example. Each service has a set of methods or actions, each with a set of optional input and output parameters or action attributes and with an optional return value(s). Methods also have return codes, indicating their successful execution or the failure of such. Thus, as illustrated in FIG. 1, the control point 10 invokes action on a service (message 18) and receives a return value (message 20) in response.

According to the UPnP architecture, control points can request that device services notify them when a state change occurs within the service. FIG. 2 illustrates this capability. In FIG. 2, service 14 of device 12 has an associated state table 22 that stores a record of the relevant “evented” state variables utilized by that service. Control point 10 sends a subscription message 24 to device 12, and this operation causes device 12 to send control point 10 a notification (message 26) when any values in state table 22 change. UPnP architecture thus allows a control point to learn of state changes without having to continually poll devices for changes. The ability of a control point to discover devices, invoke actions on a device's services and subscribe to events are some fundamental capabilities prescribed by the UPnP architecture. Device services, on the other hand, respond to invoked actions and send events when “evented” state variables change. According to the UPnP architecture, UPnP devices follow a basic pattern that define phases of operation. These are illustrated in FIG. 3.

Referring to FIG. 3, a UPnP device joins the network in the first instance during an addressing phase 30. During this phase the device acquires a unique address that others can use to communicate with it. After the advertising phase, the description phase 32 is invoked. In this phase the device summarizes its services and capabilities in a standard format following XML UPnP schema. After that is complete, the discovery phase 34 is begun. During the discovery phase the device is found by control points and device descriptive information is retrieved. The discovery phase is thus the point within the UPnP cycle where control points can communicate with devices. The UPnP architecture provides three basic classes of operations that may occur. Those are illustrated in FIG. 3 as control 36, eventing 38 and presentation 40. Control is the phase where control points invoke actions or methods provided by a device's services. The device's service receives a control message and acts upon it. As a result of this interaction, the device's service may change its internal state. The eventing phase allows control points to monitor such state changes in devices. As discussed above, the UPnP architecture uses a publisher/subscriber model, where control points may subscribe to a service provided by a device. The device's service notifies all registered control points upon changes in state variables. The eventing phase thus enables the UPnP network of devices to be dynamic, responsive and event driven. The presentation phase invokes a browser-based user interface associated with the device. The user interface allows for manual user control as well as viewing of device status. The browser-based interface can be used to control the device, to change operational parameters, to view device and service information or to perform other device- specific functions implemented by the device's manufacturer.

The present profiling service extends the functionality of the basic UPnP architecture. As will be more fully explained below, the profiling service provides for automatic discovery of the available profiles. These profiles provide useful information about devices, users and/or services, and may be made available to entities on the network that are capable of exercising control (such as UPnP control points, for example). In a presently preferred embodiment, the profiles are configured as profile objects that may be expressed using well-defined XML schemas.

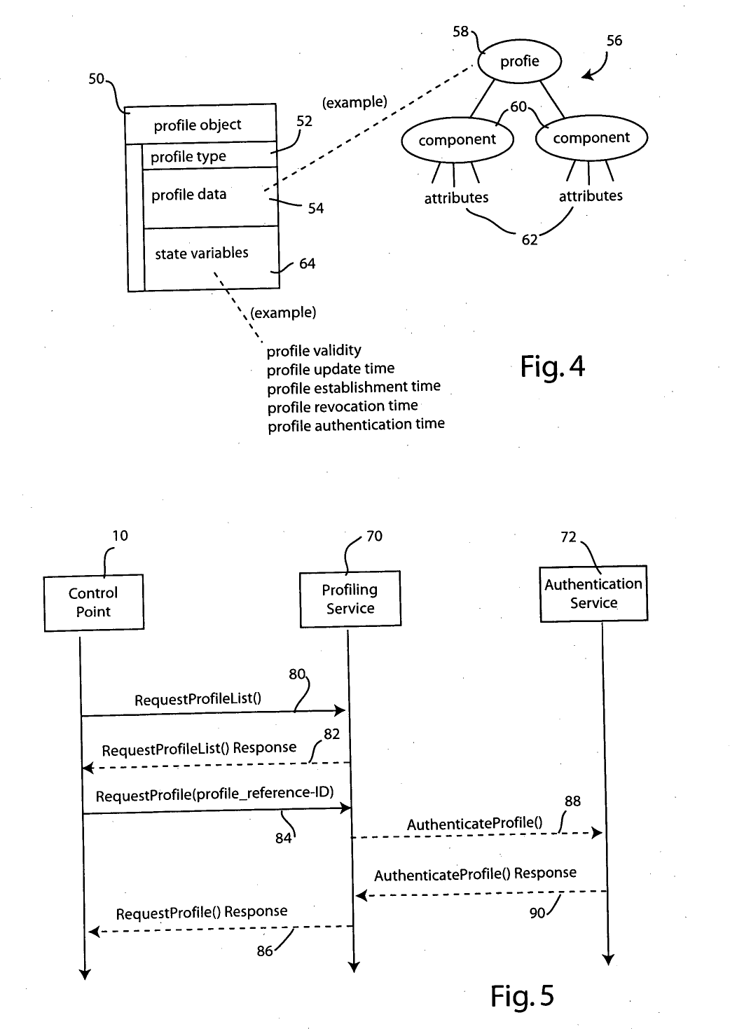

FIG. 4 illustrates an example embodiment of a profile object. The profile object 50 has an associated profile type 52. The profile type can be used to separate profile objects into different classes or categories that the profiling service can use to organize profile objects. The profile type can thus serve as an optional “search target” parameter when searching for a profiling object of a specific class.

A primary function of the profile object is to store profile data 54. The profile data is that data representing information about the object, user, network entity, hardware capabilities of the device, user display preferences and/or state of the device services: all the information UPnP consuming entity (e.g., control point) can utilize. In general, the profile data may be organized in any manner that is convenient for the application. In the illustrated example of FIG. 4, the profile data are arranged as illustrated at 56 in a tree-structured configuration where each profile data element 58 has one or more component elements 60, each having one or more profile attributes 62 (not to confuse with UPnP action attributes). Accordingly, the profile element may be structured using XML and be compatible with the Composite Capabilities/Preference Profiles (CC/PP) structure and vocabularies outlined by the W3C organization to represent a device's delivery context or other associated user preferences. Of course, other data structures and vocabularies may be used as well.

The profile object may also include a set of state variables 64. These state variables can be used for a variety of different purposes. In the presently preferred implementation, the state variables are used to store information about the profile object itself, such as the metadata concerning the profile object's validity and other timestamp information regarding when the profile was last updated, established, revoked or authenticated. The proposed profiling service may choose to expose these state variable as evented and/or moderated service state variables.

The profiling service of the invention is a novel UPnP service of the device that is responsible for a number of operations related to the profile objects, including creating the profile object, storing and updating the profile object, deleting the profile objects, and exporting information stored in profile objects to other entities on the network. These Operations are made available by means of control point invoking profiling service methods or actions.

In the presently preferred implementation, a profiling service to handle maintenance of profile objects is configured to be compliant with UPnP standards. Thus the profiling service can communicate with control points and devices within the UPnP paradigm. While the current implementation supports the UPnP version 1.0 architecture and higher, it will be understood that the principles of the invention can be readily extended to other interoperable architectures. Thus, while the present profiling service is seen as an important extension of the UPnP architecture, it is not limited to that architecture. Those skilled in the art will appreciate that the techniques described herein can be utilized in a variety of different architectures and interoperability frameworks.

Referring to FIG. 5, the profiling service 70 has been illustrated in conjunction with a control point 10. The profiling service may be also utilized in conjunction with an auxiliary authentication service 72 which has also been illustrated in FIG. 5. FIG. 5 depicts the basic messaging that occurs to implement an operative connection between a control point and the profiling service. In a UPnP environment, the profiling service 70 would be added to the network by utilizing the phases illustrated in FIG. 3. In this regard, FIG. 5 depicts message interactions that would occur after the profiling service had been advertised, described and discovered by control points on the network. The profiling service provides functionality that is not presently found in a conventional UPnP system. However, thanks to the compliant architecture, the profiling service is capable of operating within the constructs of the UPnP architecture.

Basically, the control point 10 interacts with the profiling service 70 by invoking actions and by subscribing to and receiving events. Actions may be invoked using SOAP-based UPnP actions, if desired. Events are then sent to subscribers of the profiling service when information needs to be disseminated. The profiling service may use GENA eventing protocol compliant with UPnP standards. Events are thus sent to subscribers about profile updates, profile deletions or revocations, new profile abilities, and changes in profile attributes. FIG. 5 illustrates the basic message-passing sequence. Control point 10 sends a request to the profiling service as at 80. The request is for a profile list that the profile service maintains. The profiling service then sends a reply as at 82, supplying the requesting control point 10 with a list of reference identifications of the profile objects that are available. The control point 10 then issues a request as at 84 for a specific profile, referenced by its profile reference ID. While the profiling service 70 may simply respond by providing the requested profile object XML document as at 86, an auxiliary authentication service 72 may be optionally invoked at this point. To do so, the profiling service 70 becomes a subscriber to the authentication service 72 and invokes AuthenticateProfile( ) action 88 of this authentication service 72. The authentication service verifies the authenticity of the profile and sends back a response message as at 90 regarding whether the profile is authenticated or not. The authentication service 72 may utilize a trusted third party approach in performing this verification. The authentication service could also utilize a non-repudiation of profile transactions technique. Other authentication services are also possible.

Using the profiling service 70 to store profile objects and disseminate information stored in those objects to subscribing entities allows the profile information to be propagated to all subscribing control points within the UPnP network.

The propagated profile information can be expressed through XML documents based on any suitable schema such as a UPnP forum-approved, DIDL-lite schema-based XML fragments, or CC/PP schemas, and the like.

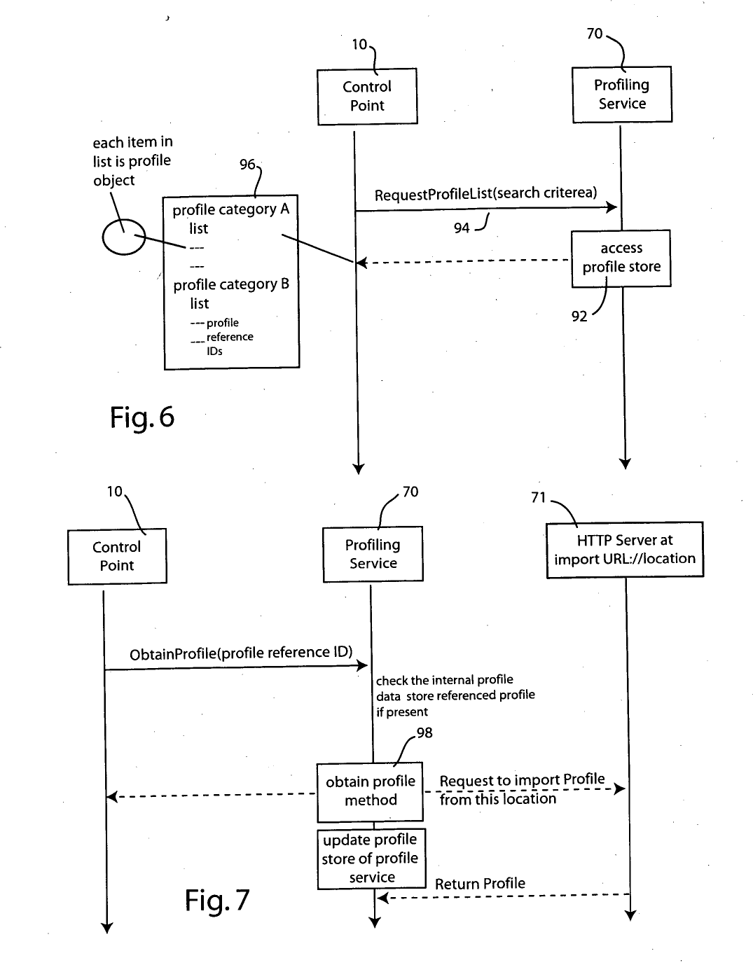

The profiling service is configured to perform a variety of actions or methods that support the profiling service. These actions or methods may be implemented as UPnP control actions using the SOAP UPnP control protocol. FIGS. 6-10 illustrate examples of the actions or methods provided by the profiling service. Other actions or methods are also possible.

Referring to FIG. 6, the profiling service 70 executes a RequestProfileList( ) action 94 to provide a list of available profiles to control point 10. The returned list 96 may be sorted into different profile categories by using the profile type information or other suitable discriminating attributes stored within the profile object (see FIG. 4). Under each profile category is a list of available profile objects reference identifiers for which information can be obtained upon request. Preferably, each item in the list refers to a valid profile object, or to another pointer to a profile object. Thus a control point referencing a given list can obtain all of the profiles referenced in that list. In other words, lists of profiles are preferably implemented as lists of references to profile objects, so that the control point can resolve these into profiles referenced in that list using available profile service methods.

FIG. 7 illustrates the ObtainProfile( ) method 98 whereby the profiling service 10 obtains a profile given the profile reference identifier or the unique URI identifier of the source location where the profile information document (i.e., profile object) can be retrieved. Once supplied with unique URI, ObtainProfile( ) method causes profiling service to retrieve profile information from the server location 71 in FIG. 7.

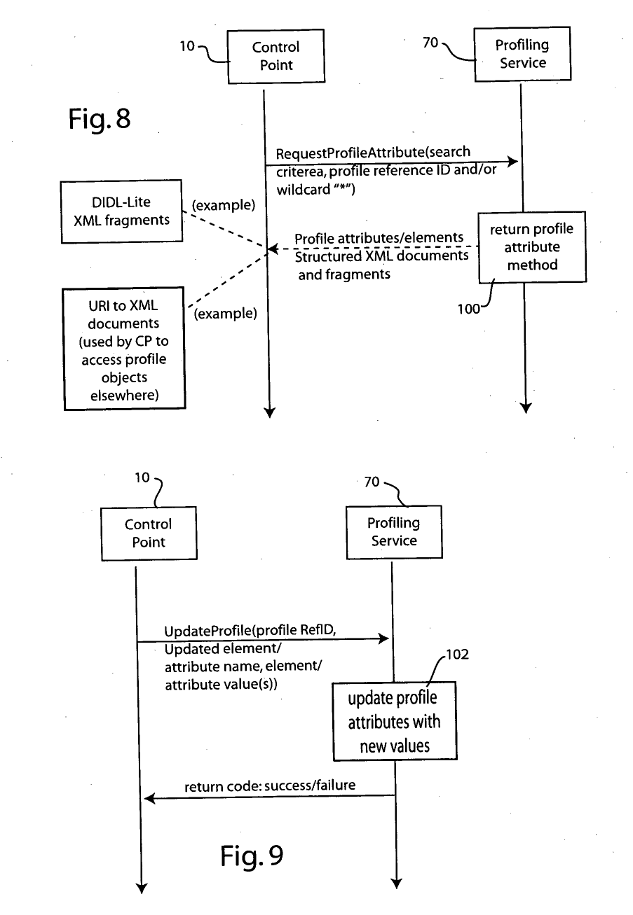

FIG. 8 illustrates the RequestProfileAttribute method 100. This method responds to a request from control point 10 for a set of profile attributes, given some search and filter criteria of requested attribute and the profile reference identification. The method returns attribute parameters to the control point. These may be expressed in a variety of different forms, including as DIDL-lite XML fragments, as Universal Resource Identifier (URI) pointers to valid XML documents stored elsewhere, and the like.

FIG. 9 illustrates the UpdateProfile( ) method 102 whereby profile information may be updated. As part of the attributes for this action profiling service supports profile attributes names and their values, as well as referencing profiles by profile referencing ID and other profile target search criteria. As a result, profile attributes and other elements may attain their new values.

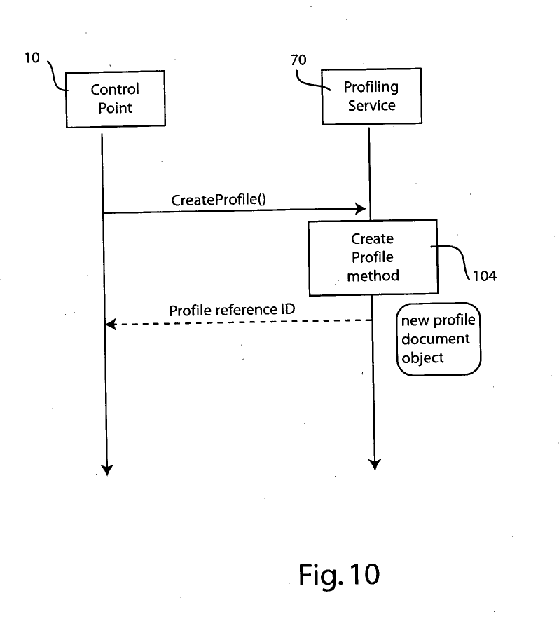

FIG. 10 illustrates the technique whereby the profiling service 70 can create a new profile document object after Control point invokes a CreateProfile( ) action 104. The Profile reference ID is returned to the control point in response to this action by control point 10 if the profile creation succeeds. Control point provides profiling service with the names and values of profile object attributes and other informational elements within the attribute list of this action.

The person skilled in the art can easily realize that the names of the proposed actions are purely suggestive in nature, and are chosen to ease the description of the profiling service functionality.

In addition to the actions or methods illustrated in FIGS. 6-10, the profiling service 70 also supports the exportation and importation feature of the referenced profile documents and their fragments. Profiles may be imported or exported to another profiling service or another HTTP or other type of server using the target uniform resource identifier supplied to perspective service actions. For example, if the following URI is supplied as the import URI: ftp://myserver.com/profile1, the profiling service will use FTP file transfer protocol to import profile1 from the server myserver into profiling service data store.

In addition to handling requests from control points and maintaining the data store of profile objects, the profiling service also administers subscriptions to its service from subscribing control points. The profiling service maintains a data store of subscribing entities and automatically sends a change event message to subscribing entities when the content of some profile(s) has changed. In this regard, the content may change because substantive profile data 54 (FIG. 4) has been changed or because the profile itself has been revoked, expires or invalidated. These latter properties may be tracked using the state variables 64 (FIG. 4). In addition to these events, the profiling service may also be configured to provide a “profile available” event to signify that additional profiles are now available. In this way, the subscribing control points do not need to continually poll to learn that new information is available for their consumption.

The profiling service of the invention extends the UPnP architecture (and other interaction architectures) by formalizing and unifying the technique whereby profile information can be propagated automatically. These services are complimentary and additive to the functionality provided by the UPnP service description document of the service. In addition, the profiling service can help control points to maintain the state of a user's interactivity with the devices and services offered. Even if the control point temporarily goes offline, the profiling service can maintain user interactivity information so that it is not lost during the temporary offline condition. For example, user display and volume settings can be retained, even if the control point undergone the powercycling.

The profiling service can be used in a wide variety of applications. These include profiling for UPnP end users, their preferences, user interface settings, hardware characteristics of associated devices, software features associated with services, networking setting, authentication setting and the like. Such profiles can cover such aspects as, for example:

hardware capabilities of devices

software capabilities of devices and services

user-specified service usage statistics

user capabilities

user preferences

networking capabilities, properties and the like.

While the invention has been described in its presently preferred embodiments, it will be understood that the invention is capable of modification and further extension without departing from the spirit of the invention as set forth in the appended claims. Accordingly, the description of the invention is merely exemplary in nature and, thus, variations that do not depart from the gist of the invention are intended to be within the scope of the invention. Such variations are not to be regarded as a departure from the spirit and scope of the invention.

1. A system for automatic service discovery and control, comprising:
a network having at least one control point entity and at least one device entity;
a profiling service entity located on said device entity configured to communicate over said network with said control point to communicate profile information documents with said control point entity;
said profiling service entity being further configured to communicate over said network with said control point and to provide profile information documents management functions to said control point
said profiling service entity being further configured to communicate over said network with said control point and to provide profile information state event notification function to said control point.

2. A system according to claim 1 wherein automatic service discovery and control system is Universal Plug and Play system.

3. A system according to claim 1 wherein said profiling service utilizes user profile information as profile information.

4. A system according to claim 1 wherein said profiling service utilizes device service state information as profile information.

5. A system according to claim 1 wherein said profiling service utilizes control point state information as profile information.

6. A system according to claim 1 wherein said profiling service utilizes universal plug and play network state information as profile information.

7. A system according to claim 1 wherein said profiling information is formatted using XML schema.

8. A system according to claim 1 wherein said profiling information is formatted using CC/PP schema.

9. A system according to claim 1 wherein said profiling service includes data store to retain said profile information as data.

10. A system according to claim 1 wherein state attributes of said service reflect attributes of the stored profile information object.

11. A system according to claim 1 wherein said service entity has an associated user and wherein said profile information relates to profiled aspects of said user.

12. A system according to claim 1 wherein said profiling service is configured to make actions available to the control point, whereby a control point invokes said actions to communicate said profile information.

13. A system according to claim 12 wherein available service actions include profile creation actions.

14. A system according to claim 12 wherein available service actions include profile update actions given the profile object identification reference.

15. A system according to claim 12 wherein available service actions include profile deletion action given the profile object identification reference.

16. A system according to claim 12 wherein available service actions include profile information exportation action given the target exportation universal resource indicator provided by said control point.

17. A system according to claim 12 wherein available service actions include profile information importation action given the profile information source universal resource indicator provided by said control point.

18. A system according to claim 1 wherein control point subscribes to said profiling service to receive said profile information related service notification messages.

19. A system according to claim 18 wherein related service notifications include profile information change event notification.

20. A system according to claim 18 wherein related service notifications include new profile availability event notification.

21. A system according to claim 18 wherein related service notifications include existing profile revocation event notification.

22. A system according to claim 1 wherein said service employs state variables to describe the validity of the stored profile information.

23. A system according to claim 1 wherein said service employs state variables to describe the timing information pertaining to profile information update by said control point.

24. A system according to claim 1 wherein said profiling service is configured to perform a method to return a profile list in response to a request from control point.

25. A system according to claim 24 wherein said profile list embeds at least one profile object for communicating to said control point upon request.

26. A system according to claim 24 wherein available service action returns complete profile object content in response to control point's specification of a profile object identification reference.

27. A system according to claim 24 wherein available service action returns a list of profile categories available in said service profile data store.

28. A system according to claim 1 further comprising authentication service entity coupled to said network and configured to communicate with said profiling service entity and said control points to authenticate said profile information.

29. A system according to claim 1 wherein said profiling service is configured to perform a method to return said filtered and customizable profile information in response to a search criteria request from control point.

30. A system according to claim 1 further including user authentication entity coupled to said profiling service and configured to communicate with said control point entity to authenticate said profile information prior to providing said profile information to said control point.

31. A system according to claim 1 wherein said profile information includes a plurality of attributes pertaining to said device entity and wherein profiling service is configured to perform a method to selectively return at least one of said attributes in response to a request from control point.
